(19) United States
(12) Patent Application Publication
(10) Pub. No.: US 2011/0154392 A1
(43) Pub. Date: Jun. 23, 2011

(54) METHOD OF PROVIDING SERVICE INFORMATION, SYSTEM THEREOF, AND METHOD OF RECEIVING SERVICE INFORMATION

(75) Inventors: Mi Young HUH, Daejeon (KR); Wook HYUN, Daejeon (KR); Shin Gak KANG, Daejeon (KR)

(73) Assignee: ELECTRONICS AND TELECOMMUNICATIONS RESEARCH INSTITUTE, Daejeon (KR)

(21) Appl. No.: 12/820,475

(22) Filed: Jun. 22, 2010

(30) Foreign Application Priority Data
Dec. 17, 2009 (KR) 10-2009-0126257

(51) Int. Cl. H04N 7/10

(52) U.S. Cl. 725/34

(57) ABSTRACT

An information providing system includes: a service provider list provider that receives a service provider list requesting message for a service that a terminal device wants and transmits a service provider list information message including a service provider list including a service provider server providing the service to the terminal device; and a service list provider that receives a service list requesting message requesting a service details list provided by the service provider server included in the service provider list from the terminal device and transmits a service list information message including the service details list provided by the service provider server to the terminal device.

### CROSS-REFERENCE TO RELATED APPLICATION

This application claims priority to and the benefit of Korean Patent Application No. 10-2009-0126257 filed in the Korean Intellectual Property Office on Dec. 17, 2009, the entire contents of which are incorporated herein by reference.

### BACKGROUND OF THE INVENTION

(a) Field of the Invention

The present invention relates to a method of providing services for a service user to use various service provider information and various services etc. provided by service providers without depending on a service provider server.

(b) Description of the Related Art

An Internet protocol television (IPTV) service is a service providing various services such as broadcasts or motion picture contents, Internet search, etc. to a TV coupled with a set-top box designated for each service provider through an Internet network.

In general, after an IPTV service user purchases a set-top box of a predetermined IPTV service provider, the IPTV service user connects the set-top box to the TV to use the IPTV service. However, since the set-top box provides only the service provided by the predetermined IPTV service provider, a user needs to purchase a new set-top box of an IPTV service provider B in order to change the existing IPTV service provider A to the IPTV service provider B. Further, the IPTV service user can only use an IPTV service provided from his/her subscribing IPTV service provider. That is, after the IPTV service user purchases a set-top box of a predetermined IPTV service provider, the IPTV service user can only use the service provided from the corresponding IPTV service provider.

Meanwhile, since it is expected that an IPTV terminal will be verified from the existing TV coupled with the set-top box or TV with the built-in set-top box to a PC-type high-performance terminal including a keyboard, a mouse, etc., a mobile terminal and various terminals search subordinate service providers and services subordinated for each provider to cause various problems such as an increase in terminal price due to redundant development.

Therefore, the IPTV service user requires a method for using information on various service providers, various services, etc. without being dependent on the service provider.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of providing services for a service user to use information on a plurality of service providers and various services provided by the service providers through portal sites without depending on a service provider server.

An exemplary embodiment of the present invention provides a method in which a service provider list and service list providing system provides information to a terminal device, that includes: receiving, from the terminal device, a service provider server list requesting message for a service that the terminal device wants; searching the service provider list providing the service; and transmitting a service provider list information message including the searched service provider list to the terminal device.

According to the exemplary embodiment of the present invention, the method in which a service provider list and service list providing system provides information to a terminal device may further include: receiving, from the terminal device, a service list requesting message requesting the service details list provided by the service provider server included in the searched service provider list; searching the service details list provided by the service provider server included in the searched service provider list; and transmitting a service list information message including the searched service details list to the terminal device.

Another embodiment of the present invention provides an information providing system that includes: a service provider list provider that receives a service provider list requesting message for a service that a terminal device wants and transmits a service provider list information message including a service provider list including a service provider server providing the service to the terminal device; and a service list provider that receives, from the terminal device, a service list requesting message requesting a service details list provided by the service provider server included in the service provider list and transmits a service list information message including the service details list provided by the service provider server to the terminal device.

Yet another embodiment of the present invention provides a method in which a terminal device receives information from a service provider list and service list providing system, that includes: transmitting a service provider list requesting message for a desired service to the service provider list and service list providing system; receiving a service provider list information message including a service provider list related to the desired service from the service provider list and service list providing system; and accessing contents of a service by performing an authentication procedure with a corresponding service provider server.

According to an embodiment of the present invention, it is possible to provide a method of providing services for a service user to use information on a plurality of service providers and various services provided by the service providers through portal sites without depending on a service provider server.

### BRIEF DESCRIPTION OF THE DRAWINGS

FIG. 1 is a diagram conceptually illustrating a service providing system according to an exemplary embodiment of the present invention;

FIG. 2 is a flowchart illustrating a method of providing services according to an exemplary embodiment of the present invention;

FIG. 3 is a diagram illustrating one example of a service provider list requesting message according to an exemplary embodiment of the present invention;

FIG. 4 is a diagram illustrating one example of a service provider list information message according to an exemplary embodiment of the present invention;

FIG. 5 illustrates service provider list information included in a body part 46 in the case where a terminal device 100 can process information on a plurality of service provider servers providing predetermined services;

FIG. 6 illustrates service provider information included in a body part 46 in the case where a terminal device 100 can process only content about one service provider server among a plurality of service provider servers providing predetermined services;

FIG. 7 is a diagram illustrating one example of a service list requesting message according to an exemplary embodiment of the present invention;

FIG. 8 is a diagram illustrating one example of a service list information message according to an exemplary embodiment of the present invention;

FIG. 9 illustrates service details information included in a body part 86 in the case where a terminal device 100 has an ability to process all service details information provided by a plurality of service provider servers providing predetermined services;

FIG. 10 illustrates service details information included in a body part 86 in the case where a terminal device 10 can process only detailed service information by one service provider server among a plurality of service provider servers providing predetermined services;

FIG. 11 is a flowchart illustrating an information management method of a service provider list provider 210 according to an exemplary embodiment of the present invention; and

FIG. 12 is a flowchart illustrating an information management method of a service list provider 220 according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

Hereinafter, a method and a system of providing services according to an exemplary embodiment of the present invention will be described in detail with reference to the accompanying drawings.

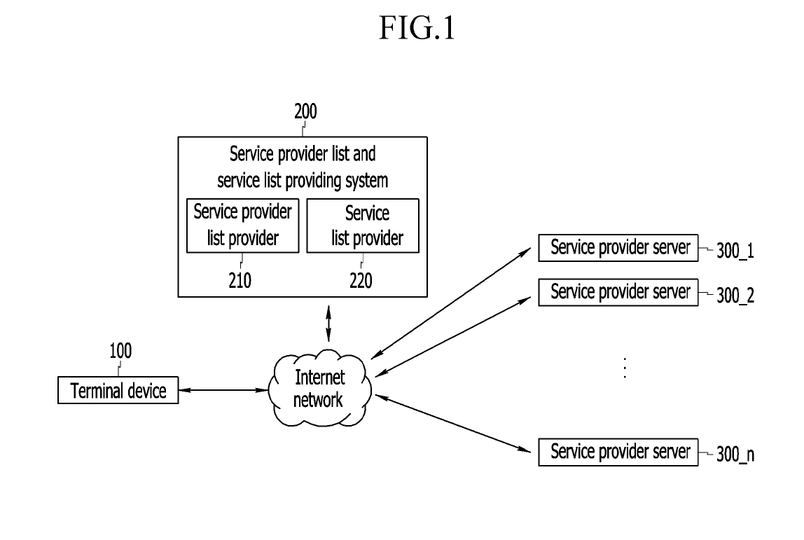

FIG. 1 is a diagram conceptually illustrating a service providing system according to an exemplary embodiment of the present invention.

Referring to FIG. 1, the service providing system according to the exemplary embodiment of the present invention includes a terminal device 100, a service provider list and service list providing system 200, and service provider servers 300_1, 300_2, . . . , 300_{—}n.

The terminal device 100 transmits a service provider list requesting message for a predetermined service to the service provider list and service list providing system 200, and receives a service provider list information message including a list of service providers providing a predetermined service from the service provider list and service list providing system 200.

Further, the terminal device 100 transmits a service list requesting message requesting a service details list of the predetermined service provided by the service provider server, which is included in the service provider list information message to the service provider list and service list provider 200, and receives the service list information message including the service details list from the service provider list and service list providing system 200.

Thereafter, the terminal device 100 selects a detailed service that the terminal device 100 will use from the received service details lists and performs an authentication procedure with a service provider server 300_{—}i providing the selected detailed service, and thereafter, accesses contents of the corresponding service.

The service provider list and service list providing system 200 includes a service provider list provider 210 and a service list provider 220, and provides service provider information providing a predetermined service and detailed information of services provided by the service provider servers 300_1, 300_2, . . . , 300_{—}n.

The service provider list and service list providing system 200 can be implemented in various forms, and for example, can be implemented in a form such as a portal site server providing services including e-mail, blogs, cafés, etc. on the Internet.

Each of the service provider serves 300_1, 300_2, . . . , 300_{—}n includes service contents for providing the predetermined service to the terminal device 100, and transmits detailed information of services provided by the service provider servers 300_1, 300_2, . . . , 300_{—}n to the terminal device 100 through the service provider list and service list providing system 200. Further, when each server is requested to access a predetermined detailed service from the terminal device 100, each server performs the authentication procedure and then permits access to the contents of the corresponding service.

Hereinafter, a method of providing services according to an exemplary embodiment of the present invention will be described in detail with reference to the accompanying drawings.

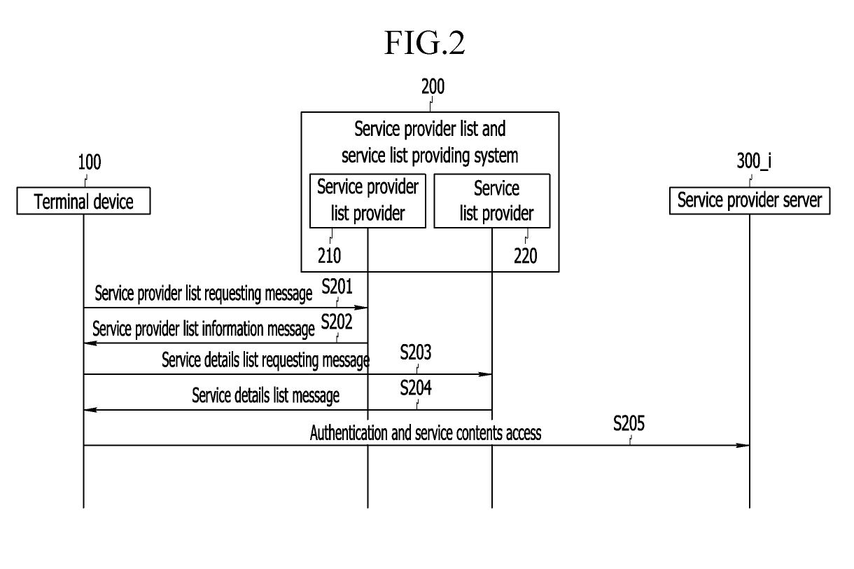

FIG. 2 is a flowchart illustrating a method of providing services according to an exemplary embodiment of the present invention.

Referring to FIG. 2, a terminal device 100 determines an Internet protocol (IP) address of a service provider list and service list providing system 200, and transmits a service provider list requesting message for a predetermined service to the determined IP address (S201).

At this time, the IP address may be pre-stored in the terminal device 100, or may be designated through environment configuration and directly inputted from a user. Further, since list information of service providers providing services of various fields may be stored in a service provider list provider 210, the service provider list requesting message includes an identifier for discriminating what kind of service provider information list the terminal device 100 requests.

Specifically, when the terminal device 100 requests a list of service providers providing an IPTV service, “IPTVSPlist”, which is an identifier representing that the terminal device 100 requests a list of service providers providing the IPTV service, is included in the service provider list requesting message.

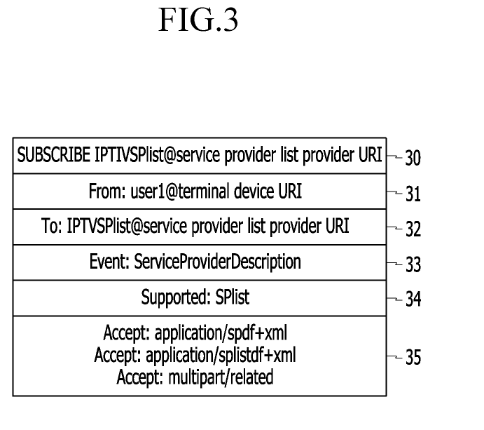

FIG. 3 is a diagram illustrating one example of a service provider list requesting message according to an exemplary embodiment of the present invention.

Referring to FIG. 3, the service provider list requesting message 30, as an SIP SUBSCRIBE message, includes a “From” header 31, a “To” header 32, an “Event” header 33, a “Supported” header 34, and an “Accept” header 35. In addition, essential headers such as “Via”, “Call-ID”, “Max-Forwards”, “CSeq”, “Contact”, etc. may be included in the message, and detailed information thereof follows the IETF RFC 3261 and the RFC 3265.

A uniform resource identifier (URI) address of the terminal device 100 is stored in the “From” header 31, and an identifier representing contents that the terminal device 100 requests and an URI address (“URI of IPTVSPlist@ service provider list provider”) of the service provider list provider 210 is stored in the “To” header 32.

Information representing (“ServiceProviderDescription”) that the terminal device 100 requests the service provider list information is stored in the “Event” header 33.

Information (“application/spdf+xml, application/splistdf+xml, multipart/related”) on a body format that the terminal device 100 can support is stored in the “Accept” header 35. The terminal device 100 may receive only the content regarding one service provider server among a plurality of service provider servers providing a predetermined service, or may receive information on all of the plurality of service provider servers providing the predetermined service depending on its performance. Therefore, the terminal device 100 transmits information representing the ability for the terminal device to process a format of the body part to the service provider list provider 210 through the “Accept” header 35.

For example, when the terminal device 100 has the ability to process only contents regarding one service provider server among a plurality of service provider servers providing a predetermine service, the terminal device 100 sets the “Accept” header 35 to “application/spdf+xml” and transmits it to the service provider list provider 210.

On the contrary, when the terminal device 100 can process information on all the plurality of service provider lists providing a predetermined service, the terminal device 100 sets the “Accept” header 35 to “application/splistdf+xml” and transmits it to the service provider list provider 210.

Further, the content representing a format of a body part of a service provider list information message that the terminal device 100 will receive is included in the “Accept” header 35. For example, when “multipart/related” is stored in the “Accept” header 35, the body part is constituted by a plurality of groups.

Meanwhile, when “application/splistdf+xml” representing that the terminal device 100 can process information on all the plurality of service provider lists is stored in the “Accept” header 35, “SPlist” is stored in the “Supported” header 34.

When a predetermined value is not stored in the “Supported” header 34 or the “Supported” header 34 is not provided in the service provider list requesting message 30, the terminal device 100 can only process contents regarding one service provider server among the plurality of service provider servers providing a predetermined service.

Referring back to FIG. 2, the service provider list provider 210 that receives the service provider list requesting message 30 from the terminal device 100 (S201) searches a service provider list stored with respect to the predetermined service that is requested from the terminal device 100, and transmits the service provider list information message 40 including the searched service provider list to the terminal device 100 (S202).

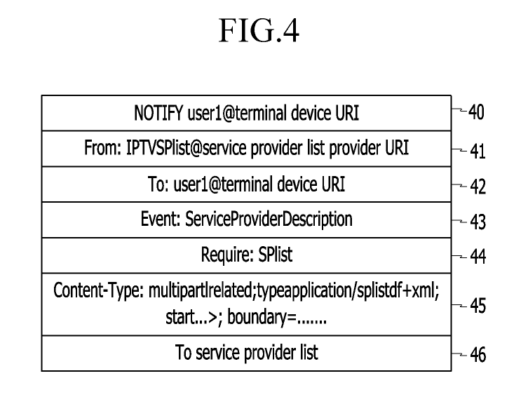

FIG. 4 is a diagram illustrating one example of a service provider list information message 40 according to an exemplary embodiment of the present invention.

Referring to FIG. 4, the service provider list information message 40, as an SIP NOTIFY message, includes a “From” header 41, a “To” header 42, an “Event” header 43, a “Require” header 44, a “Content-Type” header 45, and a body part 46. Further, essential headers of an SIP message such as “Via”, “Call-ID”, “Max-Forwards”, “CSeq”, “Contact”, etc. may be included in the message, and the detailed information thereof follows the IETF RFC 3261 and the RFC 3265. An identifier for identifying services that the terminal device 100 requests and a URI address (“URI of IPTVSPlist@service provider list provider”) of the service provider list provider 210 are stored in the “From” header 41, and the URI address of the terminal device 100 is stored in the “To” header 42.

Information (“ServiceProviderDescription”) representing that the terminal device 100 requests the service provider information is stored in the “Event” header 43, and when the terminal device 100 can process the information on the plurality of service provider servers searched as the service provider server providing the predetermined service, “SPlist” representing the case is stored in the “Require” header 44.

The contents for representing the format of the body part 46 are stored in the “Content-Type” header 45, and for example, “multipart/related” representing that the body part 46 is divided into the plurality of groups is added or when the body part 46 is divided into the plurality of groups, “type” information representing a detailed format of each group and “start” and “boundary” information representing the boundary of each group may be included.

The service provider list information providing the predetermined service that the user requests is included in the body part 46. The information included in the body part 46 may be implemented in an XML scheme and in a scheme in which the information is compressed into gzip, etc. and transmitted when the amount of information is large. Further, when the compressed information is included in the body part 46, compression information related to a compression type may be included in a predetermined part of the service provider list information message transmitted to the terminal device 100.

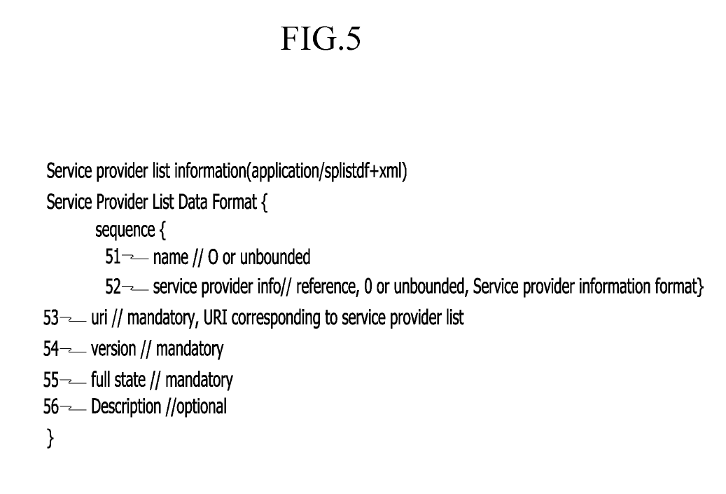

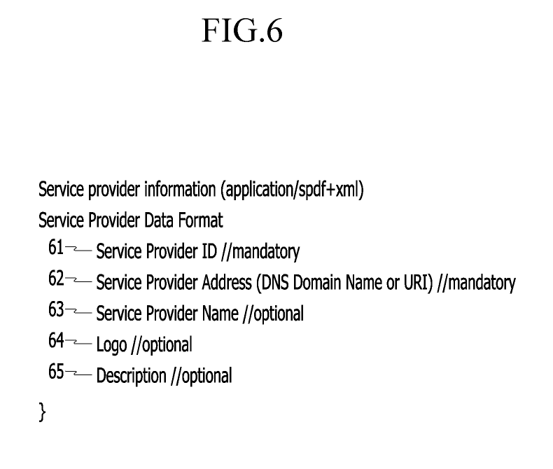

The service provider information included in the body part 46 may be implemented as shown in FIG. 5 or 6.

FIG. 5 illustrates service provider list information included in a body part 46 in the case (application/splistdf+xml) where a terminal device 100 can process information on all of a plurality of service provider servers providing predetermined services, and FIG. 6 illustrates service provider information included in a body part 46 in the case (application/spdf+xml) where a terminal device 100 can process only content about one service provider server among a plurality of service provider servers providing predetermined services.

Referring to FIG. 5, the body part 46 may repeatedly include name information 51 and service provider information 52 that are maintained in sequence, may include URI information 53, version information 54, and full state information 55, and may selectively include other list information 56 in the case (application/splistdf+xml) where the terminal device 100 can process information on all the plurality of service provider servers providing the predetermined services.

The name of the service provider corresponding to the URI information 53 is stored in the name information 51, and reference information on the service provider described as an spdf structure (application/spdf+xml) of FIG. 6 is stored in the service provider information 52 to find specific information on the corresponding service provider afterwards. The name information and the service provider information may be repeatedly included in sequence.

The URI information 53 represents a URI designating the service provider list providing the predetermined service and information notifying of a change of the service provider list information providing the predetermined service is stored in the version information 54. Specifically, the version information increases to as large as a value set whenever the service provider list providing the predetermined service is changed, and the terminal device can verify whether the service provider list providing the predetermined service is changed by using the version information 54.

The service provider list provider 210 may provide all the service provider lists providing the predetermined service to the terminal device 100, or may provide only the changed information when the terminal device 100 already has the service provider list of a predetermined version. Information representing whether all the service provider lists for the predetermined service are included in the body part 46 or only the changed information is included in the body part 46 is stored in the full state information 55.

Description information on the service provider list is stored in the other description information 56.

Referring to FIG. 6, the body part 46 may include a service provider ID 61 and a service provider server address 62, and may selectively include a service provider name 63, a logo 64, and other description information 65 in the case (application/spdf+xml) where the terminal device 100 can process only information on one service provider server among the plurality of service provider servers providing the predetermined services.

At this time, the service provider server address 62 may include a domain name, URI address information, or the like of the service provider server.

Referring back to FIG. 2, the terminal device 100 that receives the service provider list information message at step S202 transmits a service details list requesting message requesting the service details list of the predetermined service provided by the service provider server, which is included in the service provider list information message to the service list provider 220 (S203).

The detailed list of the service provided by each of the plurality of service provider servers 300_1, 300_2, . . . , 300_{—}n is stored in the service list provider 220. For example, a real-time service, a VoD service, an Internet service, etc. may be stored as detailed service contents of the IPTV service provided by the service provider server 300_1.

Accordingly, the service list requesting message includes an identifier representing that the terminal device 100 requests the detailed list of the predetermined service. For example, when the terminal device 100 requests detailed information of the IPTV service, “IPTVServicelist”, which is an identifier representing a detailed service list of the IPTV, is included in the service list request message.

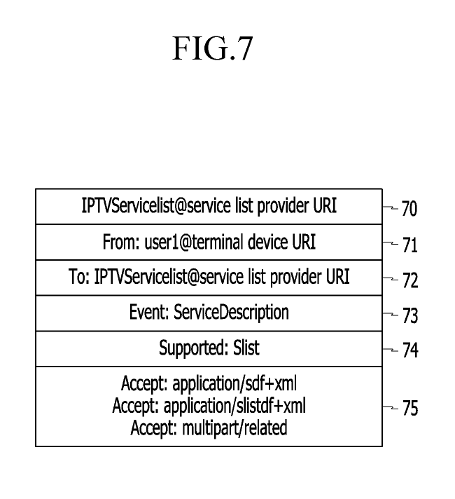

FIG. 7 is a diagram illustrating one example of a service list requesting message according to an exemplary embodiment of the present invention.

Referring to FIG. 7, a service list requesting message 70, as the SIP SUBSCRIBE message, includes a “From” header 71, a “To” header 72, an “Event”’ header 73, a “Supported” header 74, and an “Accept” header 75. Further, essential headers of an SIP message such as “Via”, “Call-ID”, “Max-Forwards”, “CSeq”, “Contact”, etc. may be included in the message, and the detailed information thereof follows the IETF RFC 3261 and the RFC 3265.

The URI address of the terminal device 100 is stored in the “From” header 71, and the identifier that the terminal device 100 requests and the URI address (URI of IPTVServicelist@service provider list provider) of the service list provider 220 are stored in the “To” header 72.

Information (“ServiceDescription”) representing that the terminal device 100 requests the service details information is stored in the “Event” header 73.

Information on a body format that the terminal device 100 can support is stored in the “Accept” header 75. The terminal device 100 may receive only the service details information provided by one service provider server among the plurality of service provider servers, and may receive all service details information provided by each of the plurality of service provider servers providing the predetermined service. Therefore, the terminal device 100 transmits information representing the processing ability of the terminal device 100 to the service list provider 220 through the “Accept” header 75.

For example, when the terminal device 10 can process only service details information provided by one service provider server among the plurality of service provider servers providing the predetermined service, the terminal device 100 sets the “Accept” header 75 to “application/sdf+xml” and transmits it to the service list provider 220.

On the contrary, when the terminal device 100 has the ability to process all the service details information provided by each of the plurality of service provider serves providing the predetermined service, the terminal device 100 sets the “Accept” header 75 to “application/slistdf+xml” and transmits it to the service list provider 220.

Further, the content representing a format of a body part of the service list information message that the terminal device 100 will receive may be included in the “Accept” header 75. For example, when “multipart/related” is stored in the “Accept” header 75, the body part is constituted by a plurality of groups.

Meanwhile, when “application/slistdf+xml” representing that the terminal device 100 can process information on all the service details information provided by the plurality of service provider servers providing the predetermined service is stored in the “Accept” header 75, “Slist” is stored in the “Supported” header 74.

When a predetermined value is not stored in the “Supported” header 74 or the “Supported” header 74 is not provided in the service provider list requesting message 70, the terminal device 100 can process only service details information provided by one service provider server among the plurality of service provider servers providing the predetermined service.

Referring back to FIG. 2, the service provider list provider 220 that receives the service list requesting message 70 from the terminal device 100 (S203) searches a service details list provided by the service provider, which is included in the service provider list information message 40, and transmits the service details information message 80 including the searched service details list to the terminal device 100 (S204).

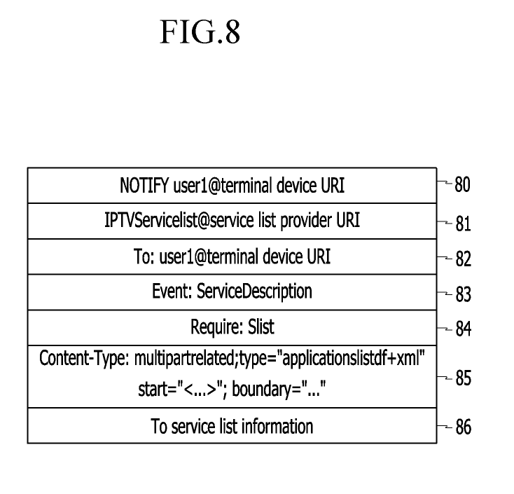

FIG. 8 is a diagram illustrating one example of a service list information message according to an exemplary embodiment of the present invention.

Referring to FIG. 8, the service list information message 80, as an SIP NOTIFY message, includes a “From” header 81, a “To” header 82, an “Event” header 83, a “Require” header 84, a “Content-Type” header 85, and a body part 86. Further, essential headers of an SIP message such as “Via”, “Call-ID”, “Max-Forwards”, “CSeq”, “Contact”, etc. may be included in the message, and the detailed information thereof follows the IETF RFC 3261 and RFC 3265.

An identifier for identifying services that the terminal device 100 requests and a URI address of the service list provider 220 are stored in the “From” header 81, and the URI address of the terminal device 100 is stored in the “To” header 82.

Information (“ServiceDescription”) representing that the terminal device 100 requests the service details information is stored in the “Event” header 83, and when the terminal device 100 can process all the service details information provided by the plurality of service provider servers providing the predetermined service, “Slist” representing the case is stored in the “Require” header 84.

The contents for representing the format of the body part 86 are stored in the “Content-Type” header 85, and for example, “multipart/related” representing that the body part 86 is divided into the plurality of groups is added, or when the body part 86 is divided into the plurality of groups, “type” information representing the processing ability of the body part 86, and “start” and “boundary” information for representing the scope of each group when the body part is divided into the plurality of groups, may be included.

The information on the service details list provided by the service provider server providing the predetermined service that the user requests is included in the body part 86. The information included in the body part 86 may be implemented in an XML scheme and in a scheme in which the information is compressed into gzip, etc. and transmitted when the amount of information is large. Further, when the compressed information is included in the body part 86, the compressed information may be included in the service list information message 80 transmitted to the terminal device 100.

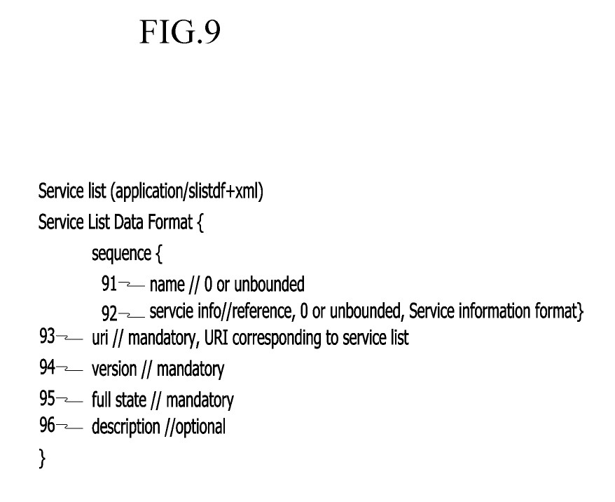

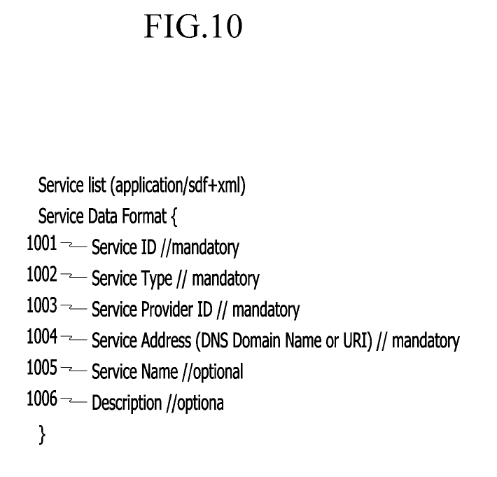

The service details information included in the body part 86 may be implemented as shown in FIG. 9 or 10.

FIG. 9 illustrates service details information included in a body part 86 in the case (application/slistdf+xml) where a terminal device 100 has an ability to process all service details information provided by a plurality of service provider servers providing predetermined services, and FIG. 10 illustrates service details information included in a body part 86 in the case (application/sdf+xml) where a terminal device 100 can process only detailed service information by one service provider server among a plurality of service provider servers providing predetermined services.

Referring to FIG. 9, the body part 86 may include URI information 93, version information 94, and full state information 95, and may selectively include service provider service information 92 and other description information 96 in the case (application/slistdf+xml) where the terminal device 100 has the ability to process all the service details information provided by the plurality of service provider servers providing the predetermined services.

A service name corresponding to the URI information 93 is stored in the name information 91, and reference information on a service described as an spdf structure (application/sdf+xml) of FIG. 10 is stored in the service information 92 to find specific information on the corresponding service provider afterwards. The name information and the service information may be repeatedly included in sequence.

The URI information 93 represents a URI address of a service list designating the service list and information notifying a change of the service details list by the service provider servers providing the predetermined services is stored in the version information 94.

Specifically, the version information 94 increases to as large as a value set whenever the service details list provided by the service provider server providing the providing the predetermined service is changed, and the terminal device can verify whether the service details list provided by the service provider servers providing the predetermined service is changed by using the version information 94.

The service list provider 220 may provide all the service lists provided by the service provider servers providing the predetermined services to the terminal device 100, or may provide only the changed information when the terminal device 100 already has the service details information list of a predetermined version. Information representing whether all the service details lists provided by the service provider servers providing the predetermined services are included in the body part 86, or only the changed information for the predetermined version included in the body part 86 is stored as the full state information 95.

Referring to FIG. 10, the body part 86 may include a service identifier 1001, a service type 1002, a service provider server identifier 1003, and a service provider server address 1004, and may selectively include a service provider server name 1005 and other description information 1006 in the case (application/sdf+xml) where the terminal device 100 can process only detailed service information provided by one service provider server among the plurality of service provider servers providing the predetermined services.

Referring back to FIG. 2, the terminal device 100 that receives the service list information message (S204) from the service list provider 220 selects a detailed service that the terminal device 100 will use from the received service details lists and performs an authentication procedure with a service provider server 300_{—}i providing the selected detailed service, and thereafter, accesses contents of the corresponding service (S205).

Herein, an information management method of the service provider list provider 210 and the service list provider 220 according to the exemplary embodiment of the present invention will be described with reference to the accompanying drawings.

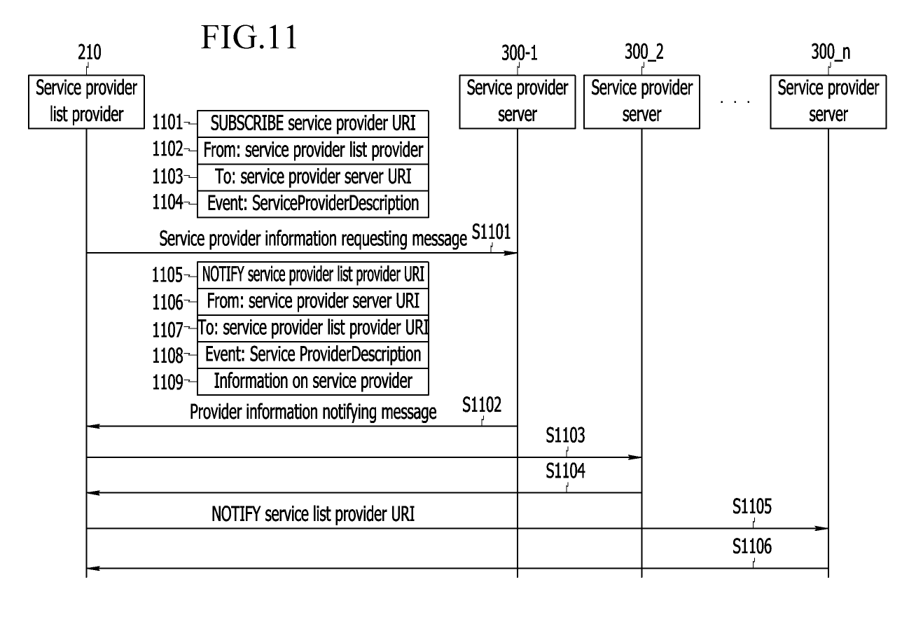

FIG. 11 is a flowchart illustrating an information management method of a service provider list provider 210 according to an exemplary embodiment of the present invention.

Referring to FIG. 11, the service provider list provider 210 transmits a service provider server list requesting message 1101 to one service provider server 300_1 among a plurality of service provider servers 300_1, 300_2, . . . , 300_{—}n (S1101). The step (S1101) of transmitting the service provider server information requesting message 1101 is cyclically performed at a predetermined cycle after a step at which the terminal device 100 determines a service provider list and an Internet protocol address of a service list providing system 200 and transmits the service provider list requesting message for a predetermined service to the determined IP address (S201) as shown in FIG. 2. The corresponding cycle information may be arbitrarily designated by the service provider list provider.

At this time, the service provider list requesting message 1101, as an SIP SUBSCRIBE message, includes a “From” header 1102 including a URI address of the service provider list provider 210, a “To” header 1103 including a URI address of the service provider server 300_1 that will receive an information requesting message, and an “Event” header 1104. Information (“ServiceProviderDescription”) representing that the service provider server 300_1 requests detailed service information provided to the terminal device 100 is stored in the “Event” header 1104.

In general, the “From” header 1102 includes information on the terminal device 100 and the service provider server 300_1 performs authentication on the basis of the information on the terminal device 100, and thereafter, opens provider information or service information. However, in the exemplary embodiment of the present invention, after the service provider server 300_1 firstly opens the provider information or the service information, the authentication is performed at a step at which the terminal device 100 accesses predetermined service contents. Therefore, URI information of the service provider list provider 210 is included in the “From” header 1102 of the service provider information requesting message 1101 according to the exemplary embodiment of the present invention.

The service provider server 300_1 that receives the service provider list requesting message 1101 transmits a provider information notifying message 1105 including information on a provided service to the service provider list provider 210 (S1102).

The information notifying message 1105, as an SIP NOTIFY message, includes a “From: header 1106, a “To” header 1107, an “Event” header 1108, and a body part 1109.

The URI address of the service provider server 300_1 is stored in the “From” header 1106, the URI address of the service provider list provider 210 is included in the “To” header 1107, and information (“ServiceProviderDescription”) representing that detailed service information provided to the terminal device 100 is requested is stored in the “Event” header 1108.

Information on a service provider provided the service provider server 300_1 is included in the body part 1109, and the body part 1109 may be implemented like the body part 46 of FIG. 4.

The service provider list provider 210 that receives the provider information notifying message from the service provider server 300_1 performs steps S701 and S702 for the remaining service provider servers 300_2, . . . , 300_{—}n (S1103 to S1106).

In the case where the service provider list provider 210 receives the provider information notifying message from the plurality of service provider servers 300_1, 300_2, . . . , 300_{—}n, lists of the plurality of service provider servers 300_1, 300_2, . . . , 300_{—}n are generated, and when changed information is provided in the case where the terminal device requests the service provider list, a terminal can be recognized by increasing a version number.

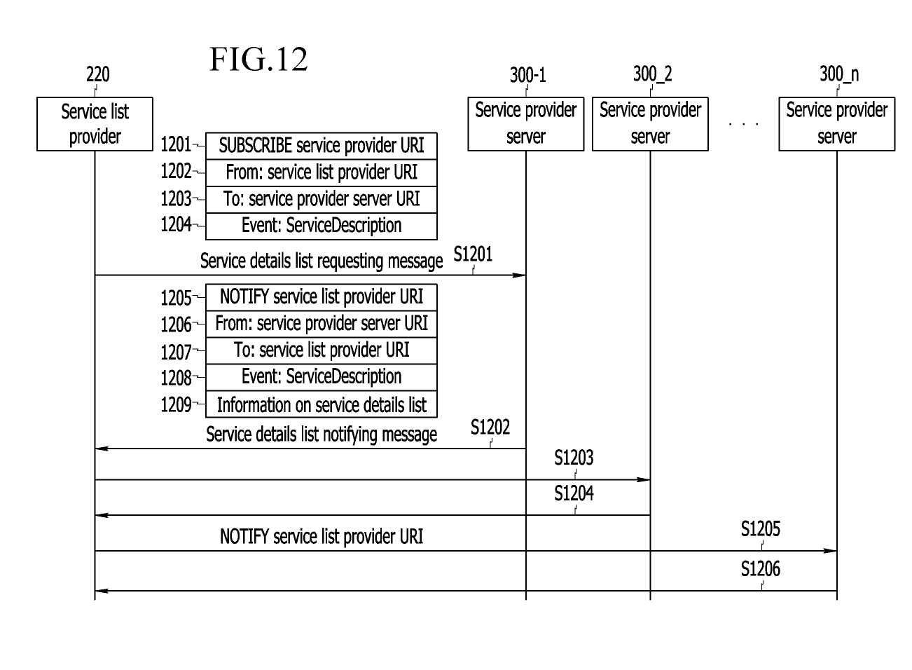

FIG. 12 is a flowchart illustrating an information management method of a service list provider 220 according to an exemplary embodiment of the present invention.

Referring to FIG. 12, the service list provider 220 transmits a service details information requesting message 1201 to one service provider server 300_1 among the plurality of service provider servers 300_1, 300_2, . . . , 300_{—}n (S1201). As such, the step (S1201) of transmitting the service details information requesting message 1201 is cyclically performed at a predetermined cycle after a step (S203) at which the service list requesting message requesting a service details list of a predetermined service provided by the service provider, which is included in the service provider list information message to the service list provider 220 in FIG. 2 described above. The corresponding cycle information may be arbitrarily designated by the service list provider.

At this time, the service provider list requesting message 1201, as an SIP SUBSCRIBE message, includes a “From” header 1202 including a URI address of the service list provider 220, a “To” header 1203 including a URI address of the service provider server 300_1 that will receive a service details information requesting message, and an “Event” header 1204. Information (“ServiceDescription”) representing that the service provider server 300_1 requests detailed service information provided to the terminal device 100 is stored in the “Event” header 1204.

The service provider server 300_1 that receives the service details information requesting message 1201 transmits the service details list information notifying message 1205 including service details information of a provided service to the service list provider 220 (S1202).

The service details list information notifying message 1205, as an SIP NOTIFY message, includes a “From” header 1206, a “To” header 1207, an “Event” header 1208, and a body part 1209.

The URI address of the service provider server 300_1 is stored in the “From” header 1206, the URI address of the service list provider 220 is included in the “To” header 1207, and information (“ServiceDescription”) representing that detailed service information provided to the terminal device 100 is requested is stored in the “Event” header 1208.

Service details information provided by the service provider server 300_1 is included in the body part 1209, and the body part 1209 may be implemented like the body part 46 of FIG. 4.

The service list provider 220 that receives the service details list information notifying message from the service provider server 300_1 performs steps S1201 and S1202 for the remaining service provider servers 300_2, . . . , 300_{—}n (S1203 to S1206).

In the case where the service list provider 220 receives the service details list information notifying message from the plurality of service provider servers 300_1, 300_2, . . . , 300_{—}n, a service details list is generated by gathering service details list notifying messages received from the plurality of service provider servers 300_1, 300_2, . . . , 300_{—}n, and when changed information is provided in the case where the terminal device requests the service list, the terminal can be recognized by increasing the version number.

According to the exemplary embodiment of the present invention, the terminal device 100 can determine and use the service provider list and the service provided by each of the plurality of service provider servers 300_1, 300_2, . . . , 300_{—}n by using the service list providing system 200.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a service provider list and service list providing system provides information to a terminal device, comprising:
receiving, from the terminal device, a service provider list requesting message for a service that the terminal device wants;
searching the service provider list comprising a service provider providing the service; and
transmitting a service provider list information message comprising the searched service provider list to the terminal device.

2. The method of claim 1, wherein
the service provider list requesting message
comprises information on text format of the service provider list information message, and
the information on the text format represents any one of a first text format comprising contents regarding one service provider server providing the service and a second text format including contents regarding all of a plurality of service provider servers providing the service.

3. The method of claim 2, wherein,
in the case where the information on the text format represents the second text format,
the service provider list information message comprises:
a version of the service provider list providing the service; and
information representing whether all the service provider servers providing the service are included or only information on a service provider server list that is changed in a current version compared with the previous version is included.

4. The method of claim 2, wherein,
in the case where the information on the text format represents the first text format,
the service provider list information message comprises an identifier and address information of the one service provider server.

5. The method of claim 1, wherein
the service provider list request message
comprises information on a type of a body part of the service provider list information message.

6. The method of claim 1, further comprising:
transmitting a service provider information requesting message to a plurality of service provider servers; and
receiving a provider information notifying message on the service provided by the service provider server from each service provider server.

7. The method of claim 6, further comprising:
generating a service provider list for each service on the basis of the plurality of provider information notifying messages received from the plurality of service provider servers; and
generating a version of the generated service provider list.

8. The method of claim 1, further comprising:
receiving, from the terminal device, a service list requesting message requesting a service details list provided by the service provider server comprised in the searched service provider list;
searching the service details list provided by the service provider server comprised in the searched service provider list; and
transmitting a service list information message comprising the searched service details list to the terminal device.

9. The method of claim 8, wherein
the service list requesting message
comprises information on the text format of the service list information message, and
the information on the text format represents any one of a first text format comprising contents regarding a service details list of one service provider server providing the service, and a second text format comprising contents regarding service details lists of all of a plurality of service provider servers providing the service.

10. The method of claim 9, wherein,
in the case where the information on the text format represents the second text format,
the service list information message comprises:
a version of the service details list provided by the plurality of service provider servers providing the service; and
information representing whether all the service detail lists of all the plurality of service provider servers providing the service are included or only information on the service details list that is changed in a current version compared with the previous version is included.

11. The method of claim 9, wherein,
in the case where the information on the text format represents the first text format,
the service list information message
comprises an identifier and an address of the one service provider server.

12. The method of claim 8, wherein
the service list request message
comprises information on a type of a body part of the service list information message.

13. The method of claim 8, further comprising:
transmitting a service details information requesting message to a plurality of service provider servers; and
receiving a service details list information notifying message comprising detailed information on the service provided by each service provider server from each service provider server.

14. The method of claim 13, further comprising:
generating a service details list comprising the detailed information of the service provided by the plurality of service provider servers on the basis of the plurality of service details list information notifying messages received from the plurality of service provider servers; and
generating a version of the generated service details list.

15. An information providing system, comprising:
a service provider list provider that receives a service provider list requesting message for a service that a terminal device wants and transmits a service provider list information message comprising a service provider list comprising a service provider server providing the service to the terminal device; and
a service list provider that receives, from the terminal device, a service list requesting message requesting a service details list provided by the service provider server comprised in the service provider list and transmits a service list information message comprising the service details list provided by the service provider server to the terminal device.

16. The information providing system of claim 15, wherein
the service provider list requesting message
comprises information on the text format of the service provider list information message, and
the information on the text format represents any one of a first text format comprising contents regarding one service provider server providing the service and a second text format comprising contents regarding all of a plurality of service provider servers providing the service.

17. The information providing system of claim 15, wherein
the service provider list requesting message
comprises information on a type of a body part of the service provider list information message.

18. The information providing system of claim 15, wherein
the service list requesting message
comprises information on the text format of the service list information message, and
the information on the text format represents any one of a first text format comprising contents regarding a service details list of one service provider server providing the service and a second text format including contents regarding service details lists of all of the plurality of service provider servers providing the service.

19. The information providing system of claim 15, wherein
the service list requesting message
comprises information on a type of a body part of the service list information message.

20. A method in which a terminal device receives information from a service provider list and service list providing system, comprising:
transmitting a service provider list requesting message for a desired service to the service provider list and service list providing system;
receiving a service provider list information message including a service provider list related to the desired service from the service provider list and service list providing system; and
accessing contents of a service by performing an authentication procedure with a corresponding service provider server.
